(19) United States
(12) Patent Application Publication
(10) Pub. No.: US 2024/0174300 A1
(43) Pub. Date: May 30, 2024

(54) Stackable Closure Element for Closing Openings in Beam Components

(71) Applicant: Illinois Tool Works Inc., Glenview, IL (US)

(72) Inventors: Josep VENTALLÓ, Barcelona (ES); Francisco CUERVAS, Rubi (ES); Javier ARTETA, Puente la Reina Gares (ES)

(21) Appl. No.: 18/522,454

(22) Filed: Nov. 29, 2023

(30) Foreign Application Priority Data
Nov. 30, 2022 (EP) 22210646.0
Nov. 15, 2023 (DE) 10 2023 131 872.1

(51) Int. Cl. B62D 25/24

(52) U.S. Cl. CPC B62D 25/24

(57) ABSTRACT

Disclosed is a stackable closure element for closing openings in carrier components, in particular in motor vehicles. The stackable closure element includes a plate-shaped, in particular circular, base body, preferably made of a hard component, with a cover side and a closure side, and a soft component for sealing with respect to a carrier component, which is arranged on the closure side. A structure is formed on the cover side or on the closure side, and correspondingly a counter-structure formed to correspond to the structure is formed on the closure side or on the cover side, so that at least two closure elements can be connected to one another in a stack-like manner by coupling the structure of a first closure element to the counter-structure of a further closure element.

### RELATED APPLICATIONS

The present application claims the benefit of European Patent Application No. 22210646.0, filed on Nov. 30, 2022 and German Patent Application No. 10 2023 131 872.1X, filed Nov. 15, 2023, the contents of which are hereby incorporated by reference.

### BACKGROUND

In vehicle bodies in particular, a large number of holes and openings are provided to make vehicle cavities, such as the sills, accessible from the outside, in particular to make them accessible for the entry of corrosion protection agents.

Early in the production of a motor vehicle, the body as a whole is usually subjected to phosphating in a phosphating bath. This is followed by washing in a cleaning bath and then usually cataphoretic dip coating. For all these processes, it is necessary for the corresponding liquids to also get into the cavities of a car body. For this purpose, the car body has openings and, in particular, holes that are subsequently to be sealed to prevent dirt and liquids from entering. In addition, vehicle bodies also have holes that are used to manage the production process of an alignment of individual body components until their integration into the overall body.

The known holes or openings are usually closed with rubber-elastic plugs. For this purpose, conventional rubber-elastic plugs have a central cavity in the form of a flat cup-shaped or cup-shaped region which is bounded by a first side wall and a first wall which usually closes off this region on one side.

From U.S. Pat. No. 6,319,436 B1 a plug for closing an opening in a flat surface is known with a plurality of retaining hooks and a circumferential seal, wherein ribs extend from an underside of a transverse surface of the plug, which are formed as guide elements when inserting the plug. The stopper is made of a hard plastic.

A plug for closing holes in flat objects is known from JP 61-59067, said plug being formed of an elastic material and having a first inner circumferential wall which, in one embodiment, has a circumferential step on the outside and a sealing lip cooperating therewith and can accordingly close a hole by these means. In addition, the plug can be corrugated in cross-section with an upper circumferential V-groove in which four ribs are formed.

From US 2015/0135598 A1, a rubber-elastic stopper is known, which consists of a circumferential wall and a top sealing lip formed therefrom, wherein an inner dome-like elevation is arranged on an inner circumferential surface of the wall, the roof of the dome-like elevation being formed with ribs.

EP 2 810 855 A1 discloses a sealing plug for sealing an opening in a component. This comprises a substantially annular or cylindrical shaft which is interrupted by ribs which are outwardly open and hollow. Furthermore, a sealing lip of conical design is provided on the shaft, at least one flexible folding zone being provided on the sealing lip, which can be reversibly folded in such a way that, in a folded state of the folding zone, the circumference of the sealing lip is reduced in the region of the folding zone and/or of an edge of the sealing lip.

EP 2 781 806 A1 describes a plug for closing openings. This plug comprises a radially circumferential side wall and a sealing surface formed on the side wall, wherein struts can be provided in the region between the circumferential side walls. According to one embodiment, the struts may extend to a circular element concentric with the circumferential side wall, or the struts may end in the region of a central actuating recess formed in an upper wall of the plug.

DE 201 07 612 U1 discloses a closure cap for closing an opening. This closure cap comprises a base body with a circumferential collar which merges into an elastic sealing lip resting against one side of a support. This closure lid may have struts that do not extend from one side of the collar or a radially circumferential sidewall to the other. According to another embodiment, the closure cap may have a grid-like stiffening structure, wherein corresponding interstices of the grid-like stiffening structure are foamed with PVC.

EP 2 873 894 A1 describes a sealing plug for closing an opening. It comprises an annular sealing section and an expanding section which is integral with the sealing section. This sealing plug can also have struts which are bounded approximately in the center of the sealing plug by an element arranged concentrically to the annular sealing section.

DE 10 2009 057750 A1 describes a device for insertion into an opening in a component of an automobile. In this case, a hot-melt adhesive material is applied circumferentially to a flange which, when heated, adheres the flange to a component surface in a sealing manner. The remaining areas of this device are made of a different plastic, whereby this device can be manufactured by means of a 2-component injection molding process.

CN 206 938 651 U discloses a sealing plug manufactured by a 2-component injection molding process, wherein a sealing portion may be formed of a hot-melt material and a base body is formed of a hard component. The sealing body may have a top wall in the connecting portion with the base body, which is formed by thin-walled struts to produce and connect the base body 100 made of the hard component and the sealing body made of the hot-melt material by a 2-component injection molding method.

The object of the present disclosure is to provide closure elements for closing openings, in particular in motor vehicles, and a method and a device for sealingly closing openings, in particular in motor vehicles, which provide an alternative to closure plugs and methods known from the prior art.

A further object of the present disclosure is to provide a closure element as well as a method and an apparatus for closing openings by means of such a closure element, which are of simple construction and inexpensive.

### SUMMARY

The present disclosure relates generally to a stackable closure element, substantially as illustrated by and described in connection with at least one of the figures, as set forth more completely in the claims. In one example, the present disclosure relates to a stackable closure element for closing openings in carrier components, in particular in motor vehicles.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a perspective view of a closure element according to the disclosure.

FIG. 2 illustrates a further perspective view of the closure element in a top view of a closure side.

FIG. 3 illustrates a perspective view of several closure elements joined together to form a stack.

FIG. 4 illustrates a schematic side view of a stack of closure elements.

FIG. 5 illustrates a schematic perspective view of a robot with a stack of closure elements.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

According to the disclosure, a stackable closure element is provided for closing openings in carrier components, in particular in motor vehicles. This comprises a plate-shaped, in particular circular, base body, preferably made of a hard component, with a cover side and a closure side, and a soft component for sealing with respect to a carrier component, which is arranged on the closure side, and wherein a structure is formed on the cover side or on the closure side, and correspondingly a counter-structure formed to correspond to the structure is formed on the closure side or on the cover side, so that at least two closure elements can be connected to one another in a stack-like manner by coupling the structure of a first closure element to the counter-structure of a further closure element.

The closure element according to the disclosure provides an extremely simply constructed device for closing openings in carrier components, which is of simple construction and represents an alternative to closure plugs known from the prior art.

The closure element according to the disclosure is characterized in particular by the fact that both a structure and a correspondingly formed counter-structure are provided on the closure element, so that a first closure element and a second closure element or several closure elements can be connected to one another in a simple stack-like manner. This allows a magazine or a stack of closure elements to be formed, with which closure elements can be easily kept in stock.

Furthermore, such a stack of closure elements or a corresponding magazine of closure elements is also particularly suitable for providing for a device for closing openings in carrier components.

The present disclosure allows a certain number of closure elements to be stacked to enable automatic assembly of closure elements, thereby simplifying the process.

The structure can be an annular, in particular circular-ring-shaped, connecting element with a receiving recess for receiving the counter-structure, and the counter-structure can be a cylindrical, in particular circular-cylindrical, counter connecting element, the connecting element and the counter connecting element being designed such that the connecting element can be held in the counter connecting element of a further closure element in the manner of a plug/socket connection.

The fact that the connecting element is annular, in particular circular, and the counter connecting element is cylindrical, in particular circular-cylindrical, means that they can be produced extremely easily, for example by means of a 2-component injection molding process.

Instead of a circular or circular-cylindrical design, a rectangular or polygonal design of the connecting element and the counter connecting element can also be provided.

However, the structure may also have any other suitable shape, for example, the structure may be a peg, a plug or a retaining element, wherein the counter-structure may be of corresponding design, and wherein the connecting element and the counter-connecting element are designed in such a way that the connecting element may be retained in the counter-connecting element of a further closure element.

According to all embodiments, it may preferably be provided that the structure in the counter-structure is preferably designed as a form-locking connection. If necessary, a non-force-fit or frictional connection can also be provided.

The soft component for sealing with respect to a carrier component can preferably be arranged only on the closure side.

A circular cylindrical latching device with a radially circumferential latching edge may be formed on the base body on the closure side for retention in an opening of a carrier component.

By means of such a latching device, the closure element can be securely and reliably connected in a simple manner to an opening in a carrier component or to an edge of a carrier component that delimits an opening.

The latching device can also be in the form of several latching elements arranged radially around the circumference and preferably equally spaced apart.

In the case of the closure element according to the disclosure, it is preferred that the connection to a carrier component is made via a latch or other latching means.

In this case, the soft component is then only provided as a sealing element and an appropriate material, such as an elastic rubber material, can be used for this purpose.

Alternatively, a corresponding latching device can also be dispensed with, in which case the soft component consists of an adhesive or a hot-melt adhesive which can be activated by means of laser or ultrasound or heat in order to bond the closure element to a carrier component. Alternatively, the soft component may be in the form of a foam which, like the aforementioned means, is suitable for sealing and bonding the closure element to a carrier component.

The soft component may be circular in shape and located on a radially outer edge of the base body.

Stiffening ribs may be formed on the cover side and/or the closure side.

The provision of appropriate stiffening ribs increases the stability of the closure element.

Furthermore, according to the disclosure, a method for stacking closure elements shown above is provided. This comprises the following steps.

Arranging a second closure element on a first closure element, preferably in axial alignment, applying a force to the closure elements in such a way that the closure elements are moved towards each other, and connecting the first and the second closure element by means of a structure of the first closure element and a counter-structure of the second closure element corresponding to the structure, or vice versa, so that at least two closure elements are connected to one another in a stack-like manner via the structure and the counter-structure.

Furthermore, according to the disclosure, a method for producing a closure element shown above is provided, wherein the closure element is produced by means of a 2-component injection molding process.

In particular, according to the disclosure, a device for sealingly closing an opening of a carrier component, in particular of a motor vehicle, with a closure element described above is also provided. This comprises a stack of closure elements which are connected to one another in a stack-like manner via structures and counter-structures correspondingly formed to the structures, and a robot for picking up a stack of closure elements and inserting the closure element into an opening of a carrier component so that it is closed.

Alternatively, it is also possible for the robot to grasp only a single closure element from the stack and then close an opening with it.

Furthermore, according to the disclosure, a method is provided for sealingly closing an opening of a carrier component, in particular of a motor vehicle, with the device described above. This comprises the following steps gripping a stack of closure elements which are connected to one another in a stack-like manner via structures and counter-structures formed correspondingly to the structures, and inserting a closure element into an opening of a carrier component and connecting the closure element to the carrier component.

This process can preferably be automated by means of a corresponding robot. A manual application is also conceivable. In this case, the stack is particularly suitable for holding the closure elements.

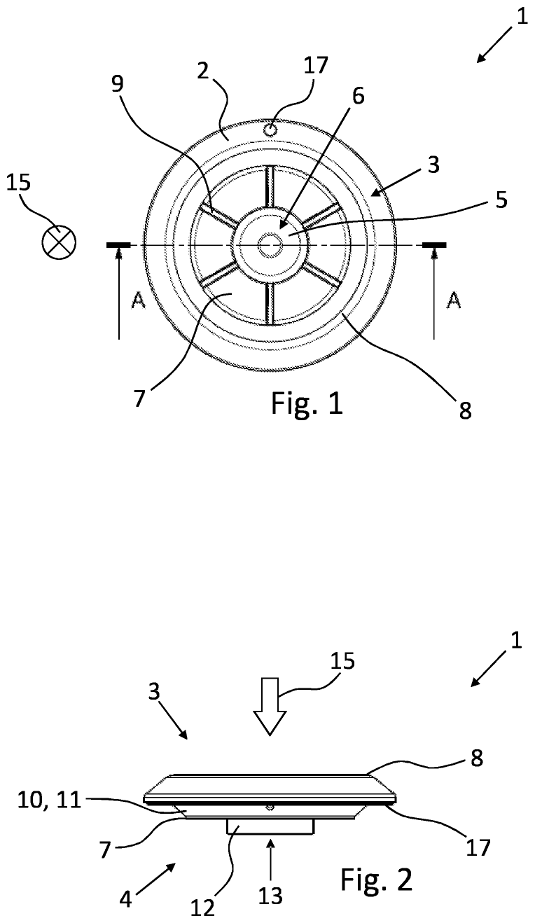

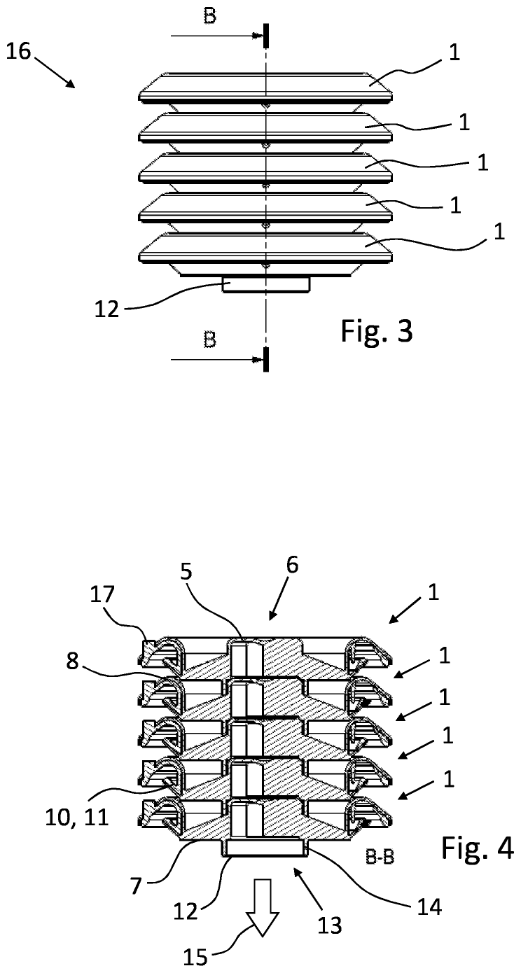

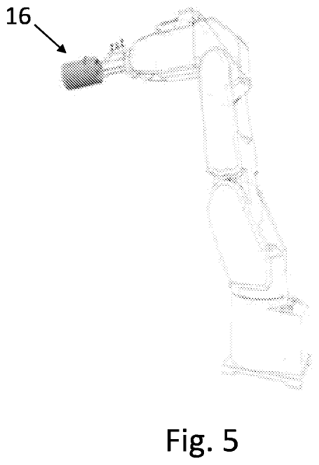

In the following, a stackable closure element 1 according to the disclosure for closing openings in carrier components, in particular in motor vehicles, is described in more detail on the basis of a first embodiment (FIGS. 1 to 5).

The closure element 1 has a circular base body 2. The base body 2 is made of a hard component and has a cover side 3 and a closure side 4.

A circular cylindrical counter connection element 5 is formed centrally in the base body on the cover side 3.

A cover-side end portion of the counter connector element 5 forms a counter-structure 6.

The cap-like counter connection element 5 merges into a radially circumferential collar 8 via a flat annular wall element 7.

The circular ring-shaped wall element 7 is connected to the counter connection element 5 in the area of the connection side 4.

The radially circumferential collar 8 is designed in particular for sealing against a support component.

For this purpose, a soft component 17 or a sealing device, preferably made of an elastic rubber material, is arranged radially circumferentially on the collar 8 in the form of a circular ring. To create a connection, in addition to the chemical connection, between the soft component and the hard component by means of a 2-component injection molding process, grooves or undercuts can be formed on the connection side of the collar 8, so that a form-locking connection is also provided.

The circular ring-shaped wall element 7 is connected to the counter connection element 5 via stiffening ribs 9. The stiffening ribs 9 are preferably formed radially circumferentially and equally spaced from each other around the counter connection element 5.

A circular-cylindrical latching device 10 with a radially circumferential latching edge 11 is formed radially circumferentially on the circular-ring-shaped wall element for retention in an opening of a carrier component.

Furthermore, a circular ring-shaped connecting element 12 is formed on the closure side 4, which delimits a receiving recess 13. This annular closure element forms a structure 14.

The counter-structure 6 of the counter connection element 5 can be received in the receiving recess 13 in such a way that a plurality of closure elements 1 can be connected to one another.

Preferably, it is provided that the structure 14 or the annular connecting element 12, respectively, is the element which extends furthest from the closure element 1 in an axial direction 15. The counter-connecting element 5 or the counter-structure 6 can be approximately flush with the radially circumferential collar 8 in the axial direction 15.

Alternatively, it may also be provided that the counter connecting element 5 extends beyond the collar 8 in the axial direction 15. It can also be provided that the annular connecting element 12 extends in the axial direction 15 beyond the annular wall element, as described above, or that the annular connecting element is approximately flush with the annular wall element 7.

Thus, it is crucial that the counter-structure 6 and/or the structure 14 extend beyond the remaining components of the closure element 1 in the axial direction 15 in order to be able to connect multiple closure elements 1 in a stack-like manner. Otherwise, a stack-like connection of two or more closure elements 1 would be difficult or impossible.

According to an alternative embodiment, no annular stiffening structures may be provided in the closure element according to the disclosure.

According to a method of stacking closure elements 1, the following steps are provided.

Arranging a second closure element 1 on a first closure element, preferably in axial alignment, in particular in axial direction 15,

applying a force to the closure element or elements in such a way that the closure elements are moved towards each other, in particular in the axial direction 15, and

Connecting the first and the second closure element 1 by means of a structure 14 of the first closure element 1 and a counter-structure 6 of the second closure element 1 formed correspondingly to the structure 14, so that at least two closure elements 1 are connected to one another in a stack-like manner via the structure 14 and the counter-structure 6, so that a stack of closure elements is provided.

A closure element according to the disclosure is produced by means of a 2-component injection molding process.

In addition, according to the disclosure, a device for sealingly closing an opening of a carrier component, in particular of a motor vehicle, with a closure element 1 is provided. The device comprises a stack of 16 closure elements 1, which are connected to one another in a stack-like manner via structures 14 and counter-structures 6 formed correspondingly to the structures, and a robot for picking up the stack of closure elements and for inserting the closure element from the stack into an opening of a carrier component so that the latter is closed.

According to an alternative embodiment, it can also be provided that the robot does not pick up the entire stack 16 of closure elements, but that the stack 16 of closure elements 1 is provided as a magazine or the like, so that the robot always grips a single closure element 1 from the stack 16 and then closes an opening of a carrier component with it.

Furthermore, a method is provided for sealingly closing an opening of a carrier component, in particular of a motor vehicle, with such a device. The method comprises the following steps gripping a stack of closure elements which are connected to one another in a stack-like manner via structures 14 and counter-structures 6 which are formed correspondingly to the structures 14, and inserting a closure element 1 into an opening of a carrier component and connecting the closure element to the carrier component preferably via corresponding latching edges 11 of a latching device 10.

The above-cited patents and patent publications are hereby incorporated by reference in their entirety. While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE SIGNS

1 Closing element

2 Base body

3 Cover side

4 Closure side

5 Counter connection element

6 Counter-structure

7 Circular disc shaped wall element

8 Collar

9 Stiffening rib

10 Latching device

11 Latching edge

12 Annular connecting element

13 Receiving recess

14 Structure

15 Axial direction

16 Stack

17 Soft component

What is claimed is:

1. A stackable closure element for closing openings in carrier components in a motor vehicle, the stackable closure element comprising
a plate-shaped, circular, base body, made of a hard component, with a cover side and a closure side, and
a soft component for sealing against a carrier component, which is arranged on the closure side, and
wherein a structure is formed on the cover side or on the closure side and a counter-structure corresponding to the structure is correspondingly formed on the closure side or the cover side, so that at least two closure elements can be connected to one another in a stack-like manner by coupling the structure of a first closure element to the counter-structure of a further closure element.

2. The stackable closure element according to claim 1, wherein the structure is an annular connecting element with a receiving recess for receiving the counter-structure, and the counter-structure is a cylindrical counter connecting element,
the connecting element and the counter connecting element are configured such that the connecting element can be held in the counter connecting element of a further closure element in the manner of a plug or socket connection.

3. The stackable closure element according to claim 1, wherein the structure is a peg, a plug or a retaining element, the counter-structure being of a corresponding design, and the connecting element and the counter-connecting element being designed in such a way that the connecting element can be retained in the counter-connecting element of a further closure element.

4. The stackable closure element according to claim 1, wherein a circular-cylindrical latching device with a radially circumferential latching edge is integrally formed on the base body on the closure side for retention in an opening of a carrier component.

5. The stackable closure element according to claim 1, wherein the soft component is formed in the shape of a circular ring and is arranged on a radially outer edge of the base body.

6. The stackable closure element according to claim 1, wherein stiffening ribs are formed on the cover side and/or closure side.

7. A method for stacking closure elements according to claim 1, the method comprising:
arranging a second closure element on a first closure element in axial alignment;
applying a force to the closure elements in such a way that the closure elements are moved towards each other; and
connecting the first and the second closure element via a structure of the first closure element and a counter-structure of the second closure element formed correspondingly to the structure, or vice versa, so that at least two closure elements are connected to one another in a stack-like manner via the structure and the counter-structure, so that a stack of closure elements is provided.

8. A method of manufacturing a stackable closure element according to claim 1, wherein the method comprises the step of manufacturing the closure element via a 2-component injection molding process.

9. A device for sealingly closing an opening of a carrier component of a motor vehicle with a closure element according to claim 1, the device comprising:
a stack of closure elements which are connected to one another in a stack-like manner via structures and counter-structures formed correspondingly to the structures; and
a robot for picking up the stack of closure elements and for inserting a closure element into an opening of a carrier component so that it is closed.

10. A method for sealingly closing an opening of a carrier component of a motor vehicle with a device according to claim 9, the method comprising:
gripping a stack of closure elements via a robot, which are connected to each other in a stack-like manner via structures and counter-structures formed correspondingly to the structures; and
inserting a closure element from the stack into an opening of a carrier component and connecting the closure element to the carrier component via the robot.
